(19) United States
(12) Patent Application Publication
(10) Pub. No.: US 2015/0055922 A1
(43) Pub. Date: Feb. 26, 2015

(54) ALL GLASS METHOD FOR FRUSTRATING INTERNAL REFLECTION IN AN OPTICAL FIBER

(71) Applicant: Corning Incorporated, Corning, NY (US)

(72) Inventors: Brian McMaster, Pittsford, NY (US); Daniel Staloff, Rochester, NY (US)

(21) Appl. No.: 14/450,743

(22) Filed: Aug. 4, 2014

Related U.S. Application Data
(60) Provisional application No. 61/868,709, filed on Aug. 22, 2013.

(51) Int. Cl. G02B 6/02; C03B 37/15; G02B 6/028

(52) U.S. Cl. CPC G02B 6/02052; G02B 6/0283; C03B 37/15; C03B 2201/86; C03B 2203/02
USPC 385/124; 385/126; 65/402

(57) ABSTRACT

The disclosure is directed to an all glass method that frustrates the internal reflection on the outside diameter of an optical fiber's glass cladding thus allowing the light to be directed to a light absorbing material/ medium and allowing the desired light in the core of the fiber to be preserved with no loss. The frustration is achieved by having at least one glass frustrater in glass-to-glass contact with the outermost cladding layer of the optical fiber. The glass frustrater is made of a glass that has a glass transition point lower that both the core and cladding glasses of the fiber. Chalcogenide and phosphate glasses are among the glasses suitable for this application.

### CROSS-REFERENCE TO RELATED APPLICATIONS

This application claims the benefit of priority under 35 U.S.C. §119 of U.S. Provisional Application Ser. No.61/868709 filed on Aug. 22, 2013 the contents of which are relied upon and incorporated herein by reference in their entirety as if fully set forth below.

### FIELD

This disclosure describes an all glass method for frustrating the internal light reflection in the outside diameter of an optical fiber's glass cladding and thus allowing the light to be directed to a light absorbing material, and thereby preserving the desired light in the core of the fiber with no loss. The disclosure is further directed to an optical fiber having at least one glass frustrater in glass-to-glass contact with the outermost cladding layer of the fiber.

### BACKGROUND

There are several methods and products available to remove unwanted light in the glass cladding of an optical fiber. These methods include free space propagation of the light and recoupling it back into a fiber, index matching polymers including fluids, gels and solids, acid etching or roughening of the outside surface of the glass cladding. The methods involve either frustrating the internal reflection of the light on the outside of the glass clad or a free space optical method of directing the light in another medium, collecting the desired light and re-coupling it back into a fiber. However, some of the drawbacks of these methods are low power level capacity, light loss, expense, stress to the fiber and complexity. Further, none of these known methods are well suited to the removal of high levels of optical power density (watts/unit area). The power density in many cases exceeds the damage threshold for the material chosen, which results in an increase of light absorption, and unwanted and excessive thermal heating. In view of the problems with the known method of frustrating light it is desirable to have a method that overcomes the foregoing problems, including operating at high power densities. The present disclosure describes an all glass method for frustrating the internal reflection in the cladding of an optical fiber.

### SUMMARY

In one aspect this disclosure describes an all glass method that frustrates the internal reflection on the outside diameter of an optical fiber's glass cladding thus allowing the light to be directed to a light absorbing material and allowing the desired light in the core of the fiber to be preserved with no loss. The subject matter of the disclosure was developed due to the need to strip the resulting light in the output cladding of an optical fiber combiner. The polymer cover on the output glass cladding was frustrating the cladding internal reflection and absorbing the light, and this absorption resulted in the heating, melting and burning of the polymer cladding material. In accord with this disclosure, organic adhesives materials, for example acrylate and urethane adhesives, are not used to bond together the frustrater and the optical fiber.

In another aspect the disclosure is directed to an all glass element or frustrater formed on the outside of a glass fiber that frustrates the internal reflection. The optical fiber has at least one glass frustrater in glass-to-glass contact with, and is bonded to, the outermost cladding layer of the fiber. The light propagates through this formed glass element and is then directed to a method of discarding the light that was frustrated. The light from the frustrater is discarded to the ambient surroundings of the fiber/frustrater combination, for example, air or a light absorbing surface. For example, the light from the frustrater is discarded into a heat exchanger.

One method of forming this glass shape on the outside of the fiber is by melting and reforming it to a desired shape around the fiber. The geometry of the glass is chosen to direct the light in any of several desired directions. The material properties of the glass shape can also be varied with respect to the material properties of optical fiber, or the glass shape can be made of the same material as the fiber itself Properties such as index of refraction, transmission, thermal expansion coefficient and glass transition temperature, can also be varied in order to optimize performance of the frustration including the re-direction.

In one embodiment, when the frustrater is formed directly in the optical fiber, the glass chosen for frustrater has a lower glass transition temperature than the lowest glass transition temperature of the fiber's core and cladding glasses, thus easing the fabrication methods. In another embodiment, where two halves of a frustrater are formed and joined together using a glass frit material, the glass frit material has a lower transition temperature than the lowest glass transition temperature of the fiber's core and cladding glasses Exemplary frustrater shapes are shown in FIG. 1 (a truncated cone) and FIGS. 5-1 to 5-6.

The disclosure is thus directed to a method for frustrating the light in the cladding of a glass optical fiber by redirecting said light, the method comprising the steps of:
providing an optical fiber having a glass core and one or a plurality of glass cladding layers overlaying said core; and
forming one or a plurality of shaped glass frustrater(s) on the outermost cladding layer of said fiber;
wherein said glass frustrater(s) is in glass-to-glass contact with and bonded to the outermost cladding layer of said optical fiber, and light entering the glass frustrater from the cladding is redirected to a light absorbing medium.

In one embodiment the frustrater(s) is/are formed on the optical fiber by placing the optical fiber in a mold having a cavity for forming the selected shape(s), injecting a glass having a glass transition temperature lower than the glass transition temperature of both the glass core and the one or plurality of cladding layers, and cooling the injected glass in the mold to thereby form the selected frustrater(s) in contact with and bonded to the outermost cladding layer of said optical fiber. In another embodiment the frustrater(s) is/are formed by bonding the frustrater(s) to the outermost cladding layer using a glass frit material having a glass transition point lower than the glass transition point of both the glass core and the one or plurality of cladding layers, the bonding being done by heating the frustrater(s), optical fiber and glass frit material to the glass transition temperature of the glass frit material. In an embodiment the glass forming the glass a frustrater is selected from the group consisting of chalcogenide glasses and phosphate glasses having a glass transition temperature of 500° C. or less.

In accordance with the method describe herein, when a plurality of glass frustraters are formed on the optical fiber, the plurality can be present in several configurations such that (a) all the frustraters are separated and not in contact with another frustrater; (b) some of the frustraters are in contact with at least one additional frustrater and some of the frustraters are not in contact with another frustrater; and (c) all of the frustraters are in contact with one another. Also in accordance with the method described herein, the refractive index of the outermost cladding layer is n_{C}, refractive index of the glass frustrater is n_{F}, and the difference between them is n_{F}−n_{C}≧0.

The disclosure is also directed to a light frustrating optical fiber comprising an optical fiber having a glass core and one or a plurality of cladding layers overlaying said core, and one or a plurality of a glass frustraters in glass-to glass contact with said outermost of said cladding layers; wherein said one or a plurality of glass frustrater(s) are in glass-to-glass contact with and bonded to the outermost cladding layer of said optical fiber, and the glass transition point of the glass forming the glass frustrater(s) is lower than the glass transition point of both the optical fiber's glass core and the one or plurality of cladding layers. In one aspect the glass forming the glass frustrater is selected from the group consisting of chalcogenide glasses and phosphate glasses having a glass transition temperature of 500° C. or less. The refractive index of the outermost cladding layer is n_{C}, refractive index of the glass frustrater is n_{F}, and the difference between them is n_{F}−n_{C}≧0.

### BRIEF DESCRIPTION OF THE DRAWINGS

FIG. 1 is an illustration of an optical fiber 12 core with a cladding 16, numeral 14 represent a cladding layer having a lower refractive than core 12 or cladding 16, light represented by arrow 10 that propagates along the cladding layer 16, numeral 11 representing the direction of light through the optical fiber, and a glass redirecting element 2 for redirecting light 10 as illustrated by arrows 19 from the cladding 16 through element or frustrater 2 and out into air or some other absorbing medium as light 10a.

FIG. 2 is a model of element shaped as a single frustrater 5-4 on a cladded optical fiber 12/16 and light 11 passing through the fiber in the direction of axis x and light 10 in the cladding emerging from the frustrater as light 10a.

FIG. 3 is a photograph illustrating within the black circle an actual shaped glass element, a frustrater 5-4, molded on a clad optical fiber 12/16.

FIG. 4 illustrates a repetition of shaped frustrater 5-4, separated by a short distance, along clad fiber 12/16 and also illustrates the light 10a that emerges from the frustraters 5-4.

FIG. 5 is an illustration of exemplary frustrater shapes 5-1 to 5-5, on a cladded optical fiber 12/16, for use in redirecting light away from the optical fiber; and the broad double headed arrow 30 underneath the FIGS. 5-1 to 5-6 is used to indicate that frustraters made according to this disclosure are operative for light hv traveling in either direction through the optical fiber.

FIG. 6 illustrates a cross section of a device/method for redirecting light through a ferrule and absorbing it. FIG. 6 illustrates the use of a frit material 20 formed on the fiber and in optical contact with a ferrule based herder 24, and a laser black coating on wedge surfaces 22 to absorb the light discarded by the ferrule frustrater.

### DETAILED DESCRIPTION

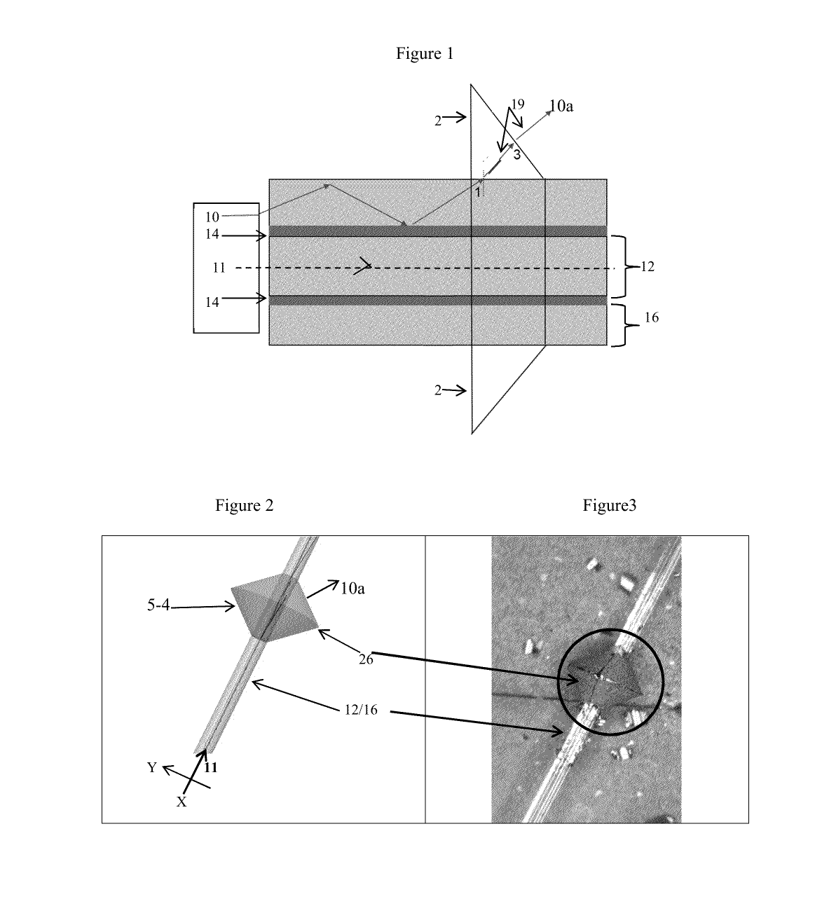

Herein, the term “optical fiber” means a glass fiber having a glass core and at least one glass cladding layer overlaying the glass core. Herein the term “frustrater” refers to the glass shape placed on the outside diameter of the glass cladding of an optical fiber to frustrate internal reflection in the cladding layer. The frustrater directs the light out of the fiber/cladding to a light absorbing material, for example, the ambient atmosphere. In accord with this disclosure, the at least one glass frustrater is in glass-to-glass contact with the outermost cladding layer of the optical fiber. Herein the terms “at last one” and “one or a plurality” have the same meaning; that is, there can be one frustrater in glass-to-glass with the fiber's outmost cladding layer or more than one frustrater in glass-to-glass with the fiber's outmost cladding layer. In addition, it is within the scope of this disclosure that when a plurality of frustraters are in glass-to-glass contact with the fiber, either (a) all the frustraters on the fiber are separated and not in contact with another frustrater, (b) some of the frustraters are in contact with at least one additional frustrater and some of the frustraters are not in contact with another frustrater, and (c) all of the frustraters are in contact with one another. Further, it is within the scope of this disclosure that when a plurality of frustraters are on a glass fiber, either the frustraters can have the same shape or they can have different shapes. FIGS. 5-1 to 5-6 provides some exemplary shapes.

This disclosure is directed to an all glass method that frustrates the internal reflection on the outside diameter of the glass cladding, allowing this light to be directed to a light absorbing material and thus allowing the desired light in the core of the fiber to be preserved with no loss. The subject matter of the disclosure was developed due to the need to strip the light in the output cladding of an optical fiber combiner. In the prior art, while the polymer cover on the output glass cladding was frustrating the cladding” internal reflection, the polymer cover was, however, absorbing the light which resulted in the heating, melting and burning of the polymer material covering the fiber.

The method disclosed herein for frustrating the light propagating in the cladding of an optical fiber enables the optical fiber to transmit at significantly higher power levels than can be transmitted through ordinary systems that use a having a polymer cover material to frustrate the light. This is due to the ability to transmit light with lower loss than a polymer, tolerate much higher temperatures than a polymer without performance degradation, and survive aggressive environmental conditions better than an index matching fluid. Compared to a free space solution, when the glass frustraters disclosed herein are used there is no loss of light in the core and the cost is significantly lower.

By creating a direct contact between the outer surface of the fiber and the frustrating shape, the difference in index of refraction between the outer surface of the fiber and the frustrater is sufficient enough to change the critical angle of internal reflection and allow the light propagating along the clad to exit the fiber. This angle is defined by Snell's law and is well understood. As has already been indicated, the light emerging from the frustrater can be directed to a light absorbing medium.

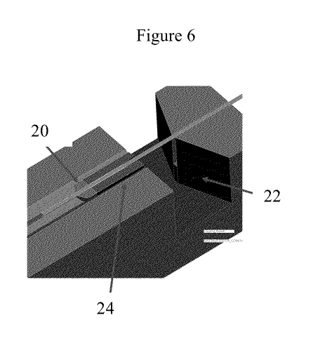

The glass shape can be formed around the outside of an optical fiber by several methods, including casting the frustrater around the fiber or placing a thin layer of a low temperature glass frit material on the fiber and bonding the frustrater to the fiber. Another method is an extrusion method in which the optical fiber is passed through a molten reservoir of frustrater mater and the frustrater shape in subsequently impressed on the molten material. Additional methods for forming the frustrater can also be used. In an embodiment of casting the frustrater about the fiber, a lower melting or glass transition point glass is used as the frustrater so as not to change the performance of the core/clad interface. In this method the frustrater is fabricated by encasing the fiber in a mold having a cavity larger that the fiber diameter, heating the mold and injecting the molten glass into a cavity surrounding the fiber. Using this method and the appropriate mold, a single frustrater can be formed at a given location, for example, frustraters 5-1 to 5-5 as illustrated in FIG. 5, or a plurality of frustraters can be formed as shown in FIG. 5-6. In FIG. 5-6.

Low melting point glasses are suitable for forming the frustraters, the exact choice of low melting glass being dependent on the particular application for which the optical fiber with frustrater will be used, and is based on the wavelength and power levels of the particular application. Generally, the low melting glass used for forming the frustrater have a glass transition temperature that is lower than the lowest glass transition temperature of optical fiber core and cladding glasses. For example, chalcogenide and phosphate glasses can be used to for the frustrater. These glasses have a glass transition temperature below 500° C. and can be formed to a desired shape without causing any adverse effects to the core optical performance (primarily diffusion between the core/clad interface).

In one embodiment the frustrater glass has an index of refraction the same as or substantially the same as the index of refraction of the fiber cladding, creates a light ray that travels through the shaped frustrater medium and intersects the next surface, for example air or some other medium, at a near normal angle. The light can then be absorbed by the air or other medium, for example a metal surface or other material, and converted to heat. The light can also be redirected into another fiber or optical system depending on the desired destination of the light originally contained in the cladding. In an embodiment the refractive index difference between the frustrater glass n_{F} and the cladding glass n_{C} is:

n_{F}−n_{C}≧0

FIG. 1 illustrates the light that is to be redirected as arrows 10 which propagate along the cladding 16 of the fiber. When the light 10 strikes the interface 1 where the cladding 16 meets the frustrater 2, it is frustrated; that is, not internally reflected. Instead, the light 10 enter the glass frustrater 2 and strikes a frustrater surface 3 where the light as 10a is refracted out of the frustrater into air or some other external medium.

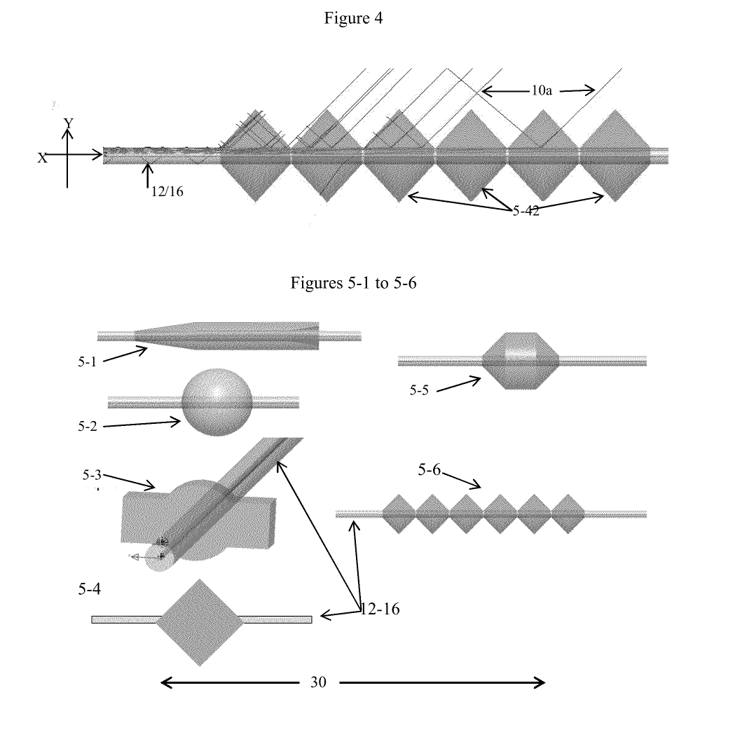

FIG. 2 is an optical model of a glass optical fiber 12/16 having a glass frustrater 5-4, and FIG. 3 is a photograph of an actual frustrater 5-5 cast about the glass optical fiber. The frustrater 5-4 is made of a chalcogenide glass and was formed using the casting method described above. FIG. 4 is an illustration of an optical fiber having a plurality of frustraters, such as those illustrated in FIG. 5-6, adjacent to one another, and the numeral 10a has the same meaning as in FIG. 1.

FIG. 5 illustrates some different frustrater shapes that can be formed and use to frustrate the light that is being internally reflected in the cladding. Additionally, one can also mix different shapes on an optical fiber and the different shapes can be in contact with one another or separated by a distance. For example without limitation, one can mix frustrater 5-4 with frustraters 5-1 to 5-3 and 5-5. These frustrater shapes, and other shapes as could be determined by one skilled in the art using this disclosure, can be molded about the clad optical fiber, or they can be pre-formed and bonded to the optical fiber using a low melting glass or glass frit material. In either case, the glass frustrater is in direct contact with the outermost cladding layer of the optical fiber. When the frustrater is pre-formed it is made from a third type of glass that is different than either the low glass transition temperature glass used for bonding the frustrater to the fiber or the glass used for the fiber cladding. The shapes illustrated in FIGS. 5-1 to 5-6 are operative in either direction of light propagation as illustrated by double headed arrow 30 below the Figures which indicates that the frustraters made according to this disclosure are operative for light hv being transmitted by the optical fiber in either direction. FIG. 5-1 illustrates a ferrule option for redirecting the light by guiding it from the frustrater into another medium, for example air or an absorbing surface. Any of these geometric examples could employ optical powered surfaces and diffractive surfaces to guide the light into a desired configuration.

It is evident from the above discussion that there must be an initial opening or passage in the frustrater to enable the optical fiber to pass through the frustrater and maintain its functional purpose of transmitting light and yet be bonded to the frustrater. In an embodiment of using a pre-formed frustrater, the frustrater is initially made in two halves, each half of which has a trough which will form the passage through the frustrater for the optical when the two halves are joined. The joining is done by coating each of the frustrater faces that will be joined and each trough with a glass frit material. The fiber is then placed in one frustrater's coated trough and the other half of the frustrater is placed over the fiber such that the frustrater faces and the troughs are aligned. The two halves are then pressed together and the entire assembly is heated to a temperature sufficient to fuse the frit material and bond the two frustrater halves together and to the optical fiber. The optical fiber is thus “passes through” the frustrater. When this method is used, the pre-formed frustrater can have a glass transition temperature near that of the optical fiber core and cladding, and the glass frit material has a lower glass transition temperature than glass frustrater material or the optical fiber material. In a another embodiment, the two halves of the frustrater have a glass transition temperature that is lower that that of the fiber and cladding. The frustrater halves are placed in a mold having a shallow trough. The fiber is placed in the trough of one mold and the two frustrater halves are pressed together and heated to a temperature sufficient to fuse them together and to the fiber.

FIG. 6 illustrates a cross section of a device/method for redirecting light through a ferrule and absorbing it. FIG. 6 illustrates the use of a frit material 20 formed on the fiber and in optical contact with a ferrule based herder 24, and a laser black coating on wedge surfaces 22 to absorb the light discarded by the ferrule frustrater. The inner diameter and outer diameter of the ferrule can be non-cylindrical if required by the application.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

We claim:

1. A method for frustrating the light in the cladding of a glass optical fiber by redirecting said light, the method comprising the steps of:
providing an optical fiber having a glass core and one or a plurality of glass cladding layers overlaying said core; and
forming one or a plurality of shaped glass frustrater(s) on the outermost cladding layer of said fiber;
wherein said glass frustrater(s) is/are in glass-to-glass contact with and bonded to the outermost cladding layer of said optical fiber, and light entering the glass frustrater from the cladding is redirected to a light absorbing medium.

2. The method according to claim 1, wherein the frustrater(s) is/are formed on the optical fiber by placing the optical fiber in a mold having a cavity for forming the selected shape(s), injecting a glass having a glass transition temperature lower than the glass transition temperature of both the glass core and the one or plurality of cladding layers, and cooling the injected glass in the mold to thereby form the selected frustrater(s) in contact with and bonded to the outermost cladding layer of said optical fiber.

3. The method according to claim 1, wherein the frustrater(s) is/are formed by bonding the frustrater to the outermost cladding layer using a glass frit material having a glass transition point lower than the glass transition point of both the glass core and the one or plurality of cladding layers,
the bonding being done by heating the frustrater(s), optical fiber and glass frit material to the glass transition temperature of the glass frit material.

4. The method according to claim 1, wherein the glass forming the glass frustrater is selected from the group consisting of chalcogenide glasses and phosphate glasses having a glass transition temperature of 500° C. or less.

5. The method according to claim 1, wherein a plurality of glass frustraters are formed on the optical fiber and the frustraters are positioned such that:
(a) all the frustraters are separated and not in contact with another frustrater;
(b) some of the frustraters are in contact with at least one additional frustrater and some of the frustraters are not in contact with another frustrater; and
(c) all of the frustraters are in contact with one another.

6. The method according to claim 1, wherein the refractive index of the outermost cladding layer is n_{C}, refractive index of the glass frustrater is n_{F}, and the difference between them is n_{F}−n_{C}≧0.

7. A light frustrating optical fiber comprising an optical fiber having a glass core and one or a plurality of cladding layers overlaying said core, and one or a plurality of a glass frustraters in glass-to glass contact with said outermost of said cladding layers;
wherein said one or a plurality of glass frustrater(s) are in glass-to-glass contact with and bonded to the outermost cladding layer of said optical fiber, and the glass transition point of the glass forming the glass frustrater(s) is lower than the glass transition point of both the optical fiber's glass core and the one or plurality of cladding layers.

8. The light frustrating optical fiber according to claim 7, wherein the glass forming the glass frustrater is selected from the group consisting of chalcogenide glasses and phosphate glasses having a glass transition temperature of 500° C. or less.

9. The method according to claim 7, wherein the refractive index of the outermost cladding layer is n_{C}, refractive index of the glass frustrater is n_{F}, and the difference between them is n_{F}−n_{C}≧0.
